(19) United States
(12) Patent Application Publication
(10) Pub. No.: US 2011/0148939 A1
(43) Pub. Date: Jun. 23, 2011

(54) DISPLAY DEVICE AND ELECTROPHORETIC DISPLAY CAPABLE OF ADJUSTING CONTRAST AND METHOD THEREOF

(75) Inventors: KUAN-HONG HSIEH, Tu-Cheng (TW); HAN-CHE WANG, Tu-Cheng (TW); HUA-DONG CHENG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/849,826

(22) Filed: Aug. 4, 2010

(30) Foreign Application Priority Data
Dec. 22, 2009 (CN) 200910312029.2

(51) Int. Cl. G09G 5/10; G09G 3/34

(52) U.S. Cl. 345/690; 345/107

(57) ABSTRACT

A method for adjusting a contrast of an electrophoretic display (EPD) includes: displaying a full white image and detecting the light intensity of the full white image; displaying a full black image and detecting the light intensity of the full black image; computing the ratio of the detected light intensity of the full white image and the detected light intensity of the full black image to obtain a contrast; comparing the contrast with a predetermined contrast value or range; and adjusting the contrast to an adjusted contrast matching the predetermined contrast or falling within a predetermined contrast range if the contrast of the second display area does not match the predetermined contrast or fall within the predetermined contrast range. A related display device and EPD are also provided.

### BACKGROUND

1. Technical Field

The present disclosure relates to displays and, particularly, to an electrophoretic displays (EPDs) capable of adjusting contrast and a method thereof.

2. Description of Related Art

Conventionally, users adjust contrast of displays such as EPDs manually. However, it may not be easy for the users to adjust the displays to the optimal contrast manually.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an EPD according to an exemplary embodiment.

FIG. 2 is a block diagram of the EPD of FIG. 1.

FIG. 3 is a flowchart of a method for adjusting contrast of the EPD of FIG. 1 according to an exemplary embodiment.

### DETAILED DESCRIPTION

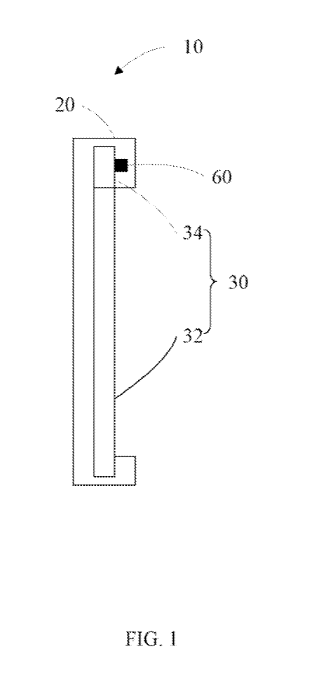

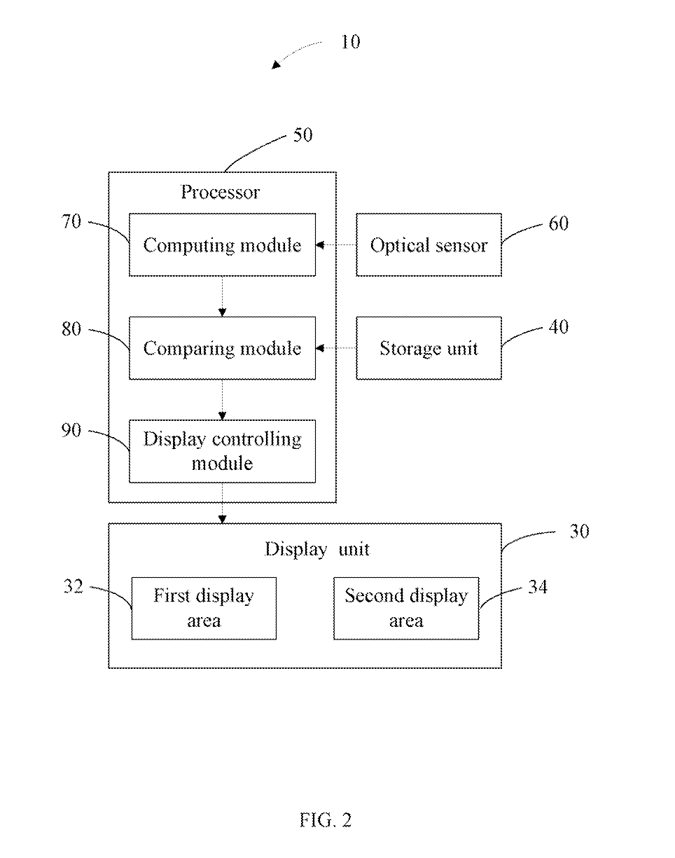

Referring to FIGS. 1 and 2, an EPD 10 according to an exemplary embodiment includes, at least, a housing 20, a display unit 30, a storage unit 40, a processor 50, and an optical sensor 60. The present invention is not limited to EPDs, the principles of the embodiments disclosed here is equally applicable to other types of displays such as LCD, EL displays, etc.

The display unit 30 is mounted in the housing 20 and includes a first display area 32 and a second display area 34. In an exemplary embodiment, the first display area 32 corresponds to a first display (not labeled) and the second display area 34 corresponds to a second display (not labeled). In an alternative embodiment, the first display area 32 and the second display area 34 correspond to a same display (not labeled). The first display area 32 is visible, and the second display area is shielded by the housing 20. The second display area 34 is configured for displaying a full white image and a full black image.

The storage unit 40 is configured for storing a predetermined contrast value or range.

The optical sensor 60 is mounted on the display unit 30 and also shielded by the housing 20. The optical sensor 60 is configured for detecting the light intensity of images displayed in the second display area 34, that is, the optical sensor 60 is configured for detecting the light intensities of the full white image and the full black image displayed in the second display area 34.

The processor 50 includes a display controlling module 90, a computing module 70, and a comparing module 80.

The display controlling module 90 is configured for displaying images in the first display area 32 and displaying the full white image and the full black image in the second display area 34 in turn according to their respective display parameters of the EPD. The display parameters may include contrast, brightness etc. The display parameters or portions of the display parameters of the first display area 32 are associated to the display parameters or portions of the display parameters of the second display area 34. In the exemplary embodiment, the contrast of first display area 32 is same as that of the second display area 34.

The computing module 70 is configured for computing the ratio of the detected light intensity of the full white image and the detected light intensity of the full black image to obtain a contrast.

The comparing module 80 is configured for comparing the contrast with the predetermined contrast value or range. If the contrast does not match the predetermined contrast value or does not fall within the predetermined contrast range, the display controlling module 90 adjusts the contrast of the first display area 32 and the second display area 34 to optimal contrast and displays images in the display area 32 based on the optimal display parameters. If the contrast matches the predetermined contrast value or falls within the predetermined contrast range, the display controlling module 90 does not adjust the contrast of the two display area 34.

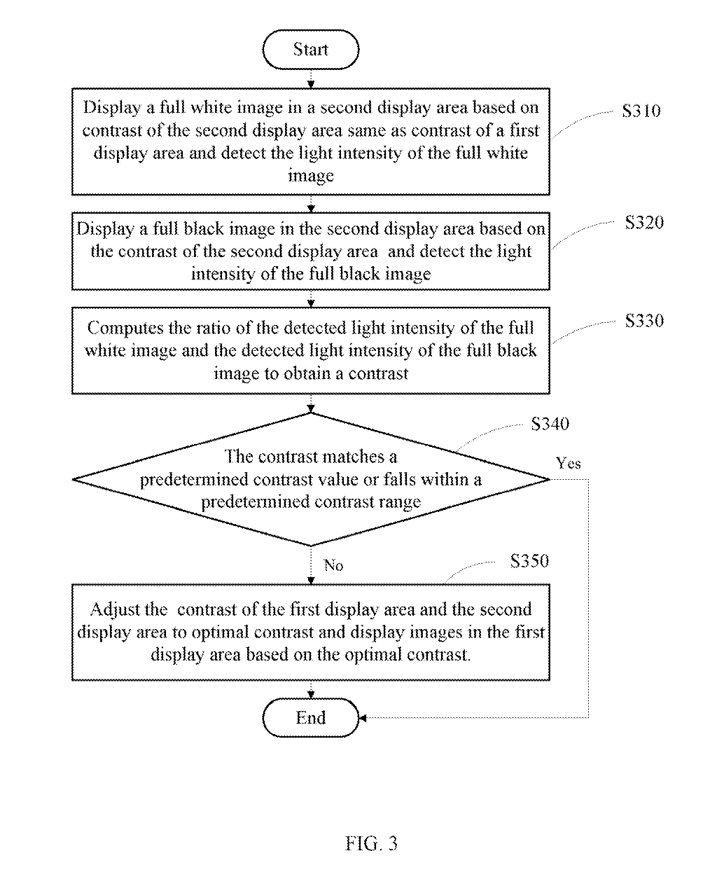

FIG. 3 is a flowchart of a method for adjusting contrast of the EPD of FIG. 1 according to an exemplary embodiment.

In step S310, the display controlling module 90 displays a full white image in a second display area 34 based on contrast of the second display area 34 same as contrast of a first display area 32 and the optical sensor 60 detects the light intensity of the full white image.

In step S320, the display controlling module 90 displays a full black image in the second display area 34 based on the contrast of the second display area 34, and the optical sensor 60 detects the light intensity of the full black image.

In step S330, the computing module 70 computes the ratio of the detected light intensity of the full white image and the detected light intensity of the full black image to obtain a contrast.

In step S340, the comparing module 80 compares the contrast with a predetermined contrast value or range. If the contrast does not match the predetermined contrast value or does not fall within the predetermined contrast range, the procedure goes to step S350. If the contrast matches the predetermined contrast value or falls within the predetermined contrast range, the procedure ends.

In step S350, the display controlling module 90 adjusts the contrast of the first display area 32 and the second display area 34 to optimal contrast and displays images in the first display area 32 based on the optimal contrast.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electrophoretic display (EPD), comprising:
a housing;
a display unit mounted in the housing and comprising a first display area and a second display area, the second display area being configured for displaying a full white image and a full black image;
a storage unit storing a predetermined contrast value or range of contrast values;
a display controlling module configured for displaying the full white image and the full black image in the second display area in turn based on contrast of the EPD;
an optical sensor configured for detecting a light intensity of the full white image and a light intensity of the full black image;
a computing module configured for computing the ratio of the detected light intensity of the full white image and the detected light intensity of the full black image to obtain a contrast; and
a comparing module configured for comparing the contrast with the predetermined contrast value or range;
the display controlling module further configured for adjusting the first display area and the second display area to an adjusted contrast matching the predetermined contrast or falling within the predetermined contrast range if the contrast does not match the predetermined contrast value or does not fall within the predetermined contrast range.

2. The EPD as described in claim 1, wherein the first display area is visible, the second display area is shielded by the housing, and the optical sensor is mounted on the display unit and also shielded by the housing.

3. A method for adjusting a contrast of an electrophoretic display (EPD), comprising:
displaying a full white image and detecting the light intensity of the full white image;
displaying a full black image and detecting the light intensity of the full black image;
computing the ratio of the detected light intensity of the full white image and the detected light intensity of the full black image to obtain a contrast;
comparing the contrast with a predetermined contrast value or range of contrast values; and
adjusting the contrast to an adjusted contrast matching the predetermined contrast or falling within a predetermined contrast range if the contrast of the second display area does not match the predetermined contrast or fall within the predetermined contrast range.

4. A display device, comprising:
a first display area and a second display area same as the first display area in contrast, the second display area being configured for displaying a full white image and a full black image;
an optical sensor configured for detecting a light intensity of the full white image and a light intensity of the full black image, wherein the light intensity of the full white image and the light intensity of the full black image are provided for obtaining a contrast of the second display area;
a display controlling module configured for adjusting the first display area and the second display area to an adjusted contrast matching a predetermined contrast or falling within a predetermined contrast range if the contrast of the second display area does not match the predetermined contrast or fall within the predetermined contrast range.

5. The display device as described in claim 4, wherein the first display area is visible to users and the second display area is invisible to the users.

6. The display device as described in claim 5, further comprising a housing, the housing shielding the second display area from visible to users.
